(19) United States
(12) Patent Application Publication
(10) Pub. No.: US 2020/0251029 A1
(43) Pub. Date: Aug. 6, 2020

(54) DISPLAY SYSTEM, DISPLAY METHOD OF DISPLAY SYSTEM AND DISPLAY DEVICE

(71) Applicant: Coretronic Corporation, Hsin-Chu (TW)

(72) Inventor: Yung-Ling Tseng, Hsin-Chu (TW)

(73) Assignee: Coretronic Corporation, Hsin-Chu (TW)

(21) Appl. No.: 16/747,456

(22) Filed: Jan. 20, 2020

(30) Foreign Application Priority Data
Jan. 31, 2019 (CN) 201910098634.8

(51) Int. Cl. G09G 3/00; G09G 3/20

(52) U.S. Cl. CPC G09G 3/005; G09G 2340/0464; G09G 2370/20; G09G 3/2088

(57) ABSTRACT

A display system, a display method of the display system and a display device are provided. The display system includes an image receiving distributer, a display device, a sensor and a host. The image receiving distributer receives an image signal, and segments the same to generate multiple sub-image signals. The display device includes multiple display panels. The display device performs image processing on the sub-image signals to generate multiple processed sub-image signals. Multiple blocks respectively form multiple portions after the image processing. The display panels respectively receive the processed sub-image signals, and respectively display the portions of a frame according to a position relationship between the display panels. The sensor provides position information generated according to the position relationship between the display panels. The host receives the position information to generate display range positioning information.

### CROSS-REFERENCE TO RELATED APPLICATION

This application claims the priority benefit of China application serial no. 201910098634.8, filed on Jan. 31, 2019. The entirety of the above-mentioned patent application is hereby incorporated by reference herein and made a part of this specification.

### BACKGROUND

### Technical Field

The invention relates to a display system, a display method of the display system and a display device.

### Description of Related Art

In application of display panels, how to splicing multiple display panels is one of the important technologies. After the image splicing is presented by the display panels, the application of the display panels is more extensive. When multiple display panels are arranged to be rotated, the frames to be displayed may be processed correspondingly. For example, the frames to be displayed may be rotated correspondingly so that the frames may be seamlessly spliced in response to the rotation arrangement of the multiple display panels.

However, regarding the existing technique, it is only a one-time frame rotation performed based on the arrangement of the same rotation of each display panel. Namely, the existing technique cannot achieve the frame-splicing display effect in case that placement of some display panels in the multiple display panels is changed.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The invention is directed to a display system, a display method of the display system and a display device, which are adapted to achieve a frame-splicing display effect in response to arbitrary assembling mode of a plurality of display panels.

The invention provides a display system including an image receiving distributer, a display device, a sensor and a host. The image receiving distributer is configured to receive an image signal, and aegment the image signal to generate a plurality of sub-image signals. The display device is coupled to the image receiving distributor. The display device includes a plurality of image processors and a plurality of display panels. The image processors are configured to respectively receive the sub-image signals, and each of the image processors performs image processing on the corresponding sub-image signals to generate a plurality of processed sub-image signals. The display panels are respectively coupled to the image processors. The image signal corresponds to a frame. The sub-image signals correspond to a plurality of different blocks of the frame, where the blocks corresponding to the sub-image signals respectively form a plurality of different portions corresponding to the processed sub-image signals after the image processing. The display panels respectively receive the processed sub-image signals, and respectively display the corresponding portions of the frame according to a position relationship between the display panels. The sensor is configured to provide position information generated according to the position relationship between the display panels. The host is coupled to the sensor and the image receiving distributor to receive the position information outputting from the sensor, and generates display range positioning information according to the position information. The image receiving distributor segments the image signal according to the received display range positioning information. Each of the image processors performs the image processing on the corresponding sub-image signals according to the display range positioning information.

The invention provides a display method of a display system. The display system includes a display device, where the display device includes a plurality of display panels and a plurality of image processors, the display panels are respectively coupled to the image processors, and the display method includes: providing position information generated according to a position relationship between the display panels; generating display range positioning information according to the position information; receiving an image signal, and segmenting the image signal according to the display range positioning information to generate a plurality of sub-image signals, where the image signal corresponds to a frame, and the sub-image signals correspond to a plurality of different blocks of the frame; respectively receiving the sub-image signals by the image sensors, and performing image processing on the sub-image signals according to the display range positioning information to generate a plurality of processed sub-image signals, the blocks corresponding to the sub-image signals respectively form a plurality of different portions corresponding to the processed sub-image signals after the image processing; and respectively receiving the processed sub-image signals by the display panels, and displaying the plurality of corresponding portions of the frame according to the position relationship between the display panels.

The invention provides a display device of a display system. The display device includes a plurality of image processors and a plurality of display panels. The image processors are configured to receive a plurality of sub-image signals generated by segmenting an image signal, and perform image processing on the sub-image signals to generate a plurality of processed sub-image signals. The display panels are respectively coupled to the image processors, where the image signal corresponds to a frame, and the sub-image signals correspond to a plurality of different blocks of the frame, and the plurality of blocks corresponding to the sub-image signals respectively form a plurality of different portions corresponding to the processed sub-image signals after the image processing. The display panels are respectively configured to receive the processed sub-image signals, and respectively display the plurality of corresponding portions of the frame according to a position relationship between the display panels. The display system provides position information generated according to the position relationship between the display panels, and generates display range positioning information according to the position information, and each of the image processors performs the image processing on the corresponding sub-image signal according to the display range positioning information.

According to the above description, the display system of the invention generates the display range positioning information according to the position information of the display panels. The image receiving distributor segments the image signal according to the received display range positioning information. Each of the image processors performs the image processing on the corresponding sub-image signals according to the display range positioning information to generate a plurality of processed sub-image signals. The display panels respectively display the processed sub-image signals to display the plurality of corresponding portions of the image according to the position relationship between the display panels. In this way, the display system achieves an image-splicing display effect in response to arbitrary assembling mode of the plurality of display panels.

Other objectives, features and advantages of the present invention will be further understood from the further technological features disclosed by the embodiments of the present invention wherein there are shown and described preferred embodiments of this invention, simply by way of illustration of modes best suited to carry out the invention.

To make the aforementioned more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a display system according to an embodiment of the invention.

FIG. 2 is a flowchart illustrating a display method according to an embodiment of the invention.

FIG. 3 is a flowchart illustrating a display method according to another embodiment of the invention.

FIG. 4 is a flowchart illustrating a display method according to still another embodiment of the invention.

FIG. 5A is a schematic diagram of a usage situation according to an embodiment of the invention.

FIG. 5B is a schematic diagram of a usage situation according to another embodiment of the invention.

FIG. 5C is a schematic diagram of a usage situation according to still another embodiment of the invention.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

Reference will now be made in detail to the present preferred embodiments of the invention, examples of which are illustrated in the accompanying drawings.

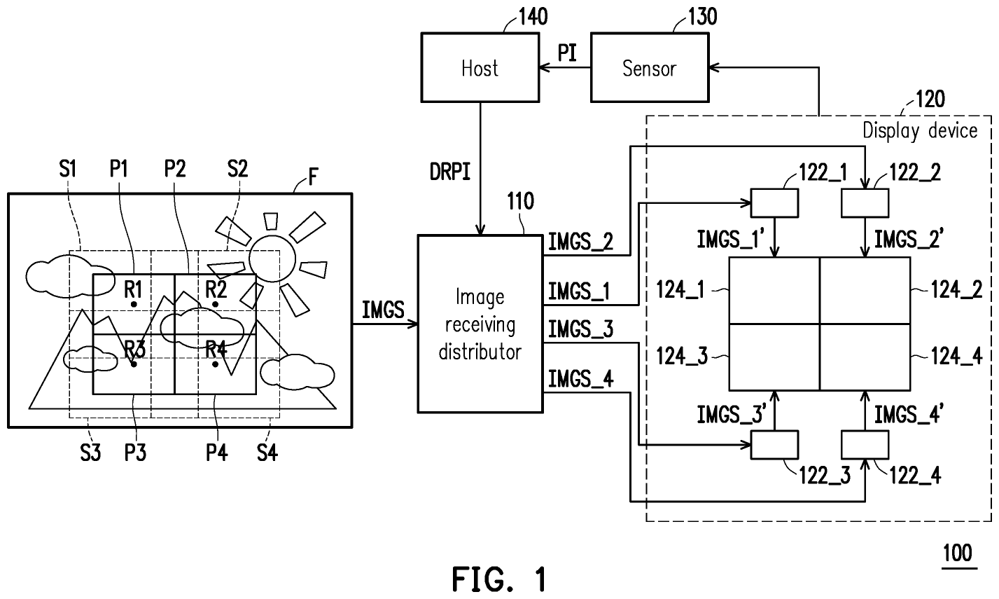

Referring to FIG. 1, FIG. 1 is a schematic diagram of a display system according to an embodiment of the invention. In the embodiment, the display system 100 includes an image receiving distributer 110, a display device 120, a sensor 130 and a host 140. The image receiving distributer 110 is configured to receive an image signal IMGS corresponding to a single frame F, and the image signal IMGS is segmented into a plurality of sub-image signals IMGS_1-IMGS_4. The sub-image signals IMGS_1-IMGS_4 correspond to a plurality of different blocks S1-S4 of the frame F respectively. For example, the sub-image signal IMGS_1 corresponds to the block S1 in the frame F, the sub-image signal IMGS_2 corresponds to the block S2 in the frame F, the sub-image signal IMGS_3 corresponds to the block S3 in the frame F, and the sub-image signal IMGS_4 corresponds to the block S4 in the frame F. In some embodiments, the image receiving distributer 110 may include an image receiver and an image distributor (not shown), where the image receiver and the image distributor may be devices independent to each other, and may be integrated into one device, which is not limited by the invention. The image receiver is configured to receive the image signal IMGS and convert a signal format of the image signal IMGS, so that the image signal IMGS may be applied to display interfaces such as a Digital Visual Interface (DVI), a High Definition Multimedia Interface (HDMI), etc. The image distributor is configured to segment the image signal IMGS to generate the sub-image signals IMGS_1-IMGS_4. Moreover, the plurality of blocks S1-S4 of the frame F corresponding to the sub-image signals IMGS_1-IMGS_4 may have partially overlapped image content, or may have no overlapped image content at all. In the embodiment, the display device 120 is coupled to the image receiving distributor 110, and is configured to receive the sub-image signals IMGS_1-IMGS_4 distributed by the image receiving distributor 110. The display device 120 includes image processors 122_1-122_4 and display panels 124_1-124_4. The image processor 122_1 is configured to receive the sub-image signal IMGS_1, and the image processor 122_1 performs image processing on the corresponding sub-image signal IMGS_1 to generate a processed sub-image signal IMGS_1′. The image processor 122_2 is configured to receive the sub-image signal IMGS 2, and performs image processing on the sub-image signal IMGS_2 to generate a processed sub-image signal IMGS 2′. The image processor 122_3 is configured to receive the sub-image signal IMGS_3, and performs image processing on the sub-image signal IMGS_3 to generate a processed sub-image signal IMGS_3′. Similarly, the image processor 122_4 is configured to receive the sub-image signal IMGS_4, and performs image processing on the sub-image signal IMGS_4 to generate a processed sub-image signal IMGS_4′. In the embodiment, the image processing includes at least one of displacement processing, rotation processing, geometric processing of a display range and warping processing. The processed sub-image signals IMGS_1′-IMGS_4′ respectively correspond to a plurality of portions P1-P4 of the frame F, and the blocks S1-S4 of the frame F corresponding to the sub-image signals IMGS_1-IMGS_4 form the portions P1-P4 of the frame F after the image processing.

The display panel 124_1 is coupled to the image processor 122_1. The display panel 124_1 receives the processed sub-image signal IMGS_1′ and displays the corresponding portion P1 of the frame F according to a position relationship between the display panels 124_1-124_4. The display panel 124_2 is coupled to the image processor 122_2. The display panel 124_2 receives the processed sub-image signal IMGS 2′ and displays the corresponding portion P2 of the frame F according to the position relationship between the display panels 124_1-124_4. The display panel 124_3 is coupled to the image processor 122_3. The display panel 124_3 receives the processed sub-image signal IMGS_3′ and displays the corresponding portion P3 of the frame F according to the position relationship between the display panels 124_1-124_4. The display panel 124_4 is coupled to the image processor 122_4. Similarly, the display panel 124_4 receives the processed sub-image signal IMGS_4′ and displays the corresponding portion P4 of the frame F according to the position relationship between the display panels 124_1-124_4. Therefore, the portions P1-P4 of the frame F corresponding to the processed sub-image signals IMGS_1′-IMGS_4′ may respectively correspond to positions of the display panels 124_1-124_4 on the display device 120. For example, the portion P1 of the frame F corresponding to the processed sub-image signal IMGS_1′ may correspond to a position of the display panel 124_1 on the display device 120. The portion P2 of the frame F corresponding to the processed sub-image signal IMGS 2′ may correspond to a position of the display panel 124_2 on the display device 120. The portion P3 of the frame F corresponding to the processed sub-image signal IMGS_3′ may correspond to a position of the display panel 124_3 on the display device 120. Similarly, the portion P4 of the frame F corresponding to the processed sub-image signal IMGS_4′ may correspond to a position of the display panel 124_4 on the display device 120.

It should be noted that the display system 100 may automatically adjust to obtain a better image-splicing display effect according to an assembling mode of the display panels 124_1-124_4 without a manual setting to adjust the image splicing. In this way, the display system 100 may implement the image-splicing display effect in response to arbitrary assembling mode of the display panels 124_1-124_4.

The display panels 124_1-124_4 of the embodiment may be display panels capable of providing a display function such as Liquid Crystal Display (LCD) display panels, Light-Emitting Diodes (LED), Organic Light-Emitting Diode (OLED) display panels, etc. The LED display panel may achieve a borderless display effect more easily than other types of displays. Therefore, the multiple LED display panels may further achieve a seamless image-splicing display effect. For simplicity's sake, the number of the image processors and the number of the display panels in the embodiment are respectively 4. The number of the image processors and the number of the display panels of the invention may be the same number greater than 1, which is not limited by the invention.

In the embodiment, the sensor 130 is configured to provide position information PI generated according to the position relationship of the display panels 124_1-124_4. The host 140 is coupled to the sensor 130 and the image receiving distributor 110. The host 140 is configured to receive the position information PI coming from the sensor 130, and generates display range positioning information DRPI according to the position information PI. The image receiving distributor 110 segments the image signal IMGS according to the received display range positioning information DRPI. The image processors 122_1-124_4 respectively perform the image processing on the sub-image signal IMGS_1-IMGS_4 according to the display range positioning information DRPI, so as to generate the processed sub-image signals IMGS_1′-IMGS_4′.

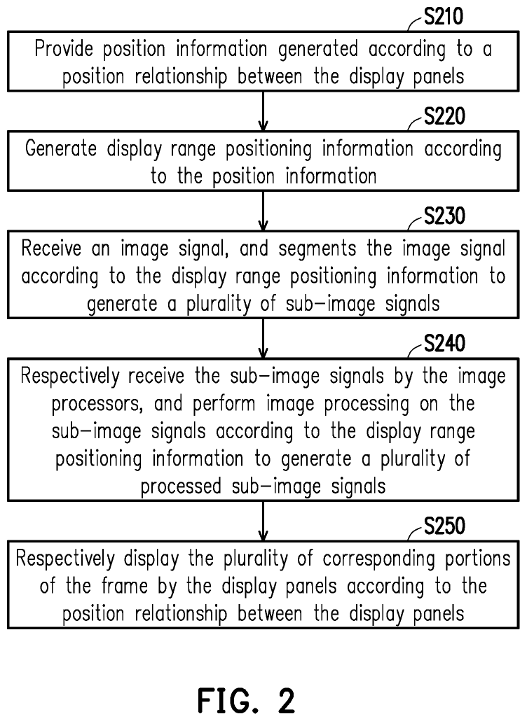

A display method of the display system is described below. Referring to FIG. 1 and FIG. 2, FIG. 2 is a flowchart illustrating a display method according to an embodiment of the invention. In the embodiment, in a step S210, the processor 130 provides the position information PI generated according to the position relationship between the display panels 124_1-124_4. In the embodiment, the display panels 124_1-124_4 and the image processors 122_1-122_4 are detachably assembled into the display device 120. Therefore, the assembling of the display panels 124_1-124_4 may be adjusted according to a usage requirement. For example, the assembling of the display panels 124_1-124_4 may be adjusted by means of at least one of displacement and rotation. The sensor 130 may provide the position information PI generated according to the position relationship between the display panels 124_1-124_4 after the display panels 124_1-124_4 are assembled.

In a step S220, the host 140 receives position information PI generated by the sensor 130, and generates the display range positioning information DRPI according to the position information PI. In the embodiment, the host 140 may calculate the relative position relationship between the display panels 124_1-124_4 and a corresponding display range according to the position information PI, so as to generate the display range positioning information DRPI. The display range positioning information DRPI determines a range of the frame F corresponding to the image signal IMGS received by the image receiving distributor 110. The display range positioning information DRPI includes shapes of the display panels 124_1-124_4 and distances and angles between the display panels 124_1-124_4. Namely, the shapes of the display panels 124_1-124_4 and the distances and angles between the display panels 124_1-124_4 determine the range of the frame F corresponding to the image signal IMGS received by the image receiving distributor 110.

In a step S230, the image receiving distributer 110 receives the image signal IMGS, and the image signal IMGS is segmented by the image receiving distributer 110 according to the display range positioning information DRPI, so as to generate the sub-image signals IMGS_1-IMGS_4. The image signal IMGS may be outputted from the host 140 or other image sources (not shown), which is not limited by the invention. In detail, the display range positioning information DRPI generated by the host 140 includes display ranges of each of the display panels 124_1-124_4 corresponding to the frame F and reference center points R1-R4 of each of the display panels 124_1-124_4 in the corresponding display ranges. The image receiving distributor 110 segments the image signal IMGS according to the display range positioning information DRPI, i.e., to generate the sub-image signals IMGS_1-IMGS_4 corresponding to the plurality of blocks S1-S4 of the frame F while taking the reference center points R1-R4 as centers.

In a step S240, the display device 120 receives the sub-image signal IMGS_1 through the image processor 122_1, receives the sub-image signal IMGS_2 through the image processor 122_2, receives the sub-image signal IMGS_3 through the image processor 122_3, and receives the sub-image signal IMGS_4 through the image processor 122_4. According to the display range positioning information DRPI, each of the image processors 122_1-122_4 of the display device 120 performs the image processing on the sub-image signal IMGS_1 to generate the processed sub-image signal IMGS_1′, performs the image processing on the sub-image signal IMGS_2 to generate the processed sub-image signal IMGS 2′, performs the image processing on the sub-image signal IMGS_3 to generate the processed sub-image signal IMGS_3′, and performs the image processing on the sub-image signal IMGS_4 to generate the processed sub-image signal IMGS_4′. In the embodiment, the image receiving distributor 110 receives the image signal IMGS and the display range positioning information DRPI, and transmits the segmented sub-image signals IMGS_1-IMGS_4 and the display range positioning information DRPI to the display device 120 all together, so that each of the image processors 122_1-122_4 performs at least one of displacement processing, rotation processing, geometric processing of a display range and warping processing on the corresponding sub-image signals IMGS_1-IMGS_4 according to the display range positioning information DRPI. The processed sub-image signals IMGS_1′-IMGS_4′ generated by the image processors 122_1-122_4 respectively correspond to the portions P1-P4 of the frame F, and the plurality of portions P1-P4 are, for example, obtained by performing the aforementioned image processing on the plurality of blocks S1-S4 of the frame F. As shown in FIG. 1, the image processor 122_1 performs geometric processing of a display range on the sub-image signal IMGS_1 according to the display range positioning information DRPI, i.e. to perform further range cutting on the block S of the frame F to generate the corresponding portion P1 of the frame F, and the image processors 122_2-122_4 perform the similar operation.

Then, in a step S250, the display device 120 receives the processed sub-image signal IMGS_1′ through the display panel 124_1, such that the display panel 124_1 may display the corresponding portion P1 of the frame F according to the position relationship between the display panels 124_1-124_4; receives the processed sub-image signal IMGS 2′ through the display panel 124_2, such that the display panel 124_2 may display the corresponding portion P2 of the frame F according to the position relationship between the display panels 124_1-124_4; receives the processed sub-image signal IMGS_3′ through the display panel 124_3, such that the display panel 124_3 may display the corresponding portion P3 of the frame F according to the position relationship between the display panels 124_1-124_4; and receives the processed sub-image signal IMGS_4′ through the display panel 124_4, such that the display panel 124_4 may display the corresponding portion P4 of the frame F according to the position relationship between the display panels 124_1-124_4.

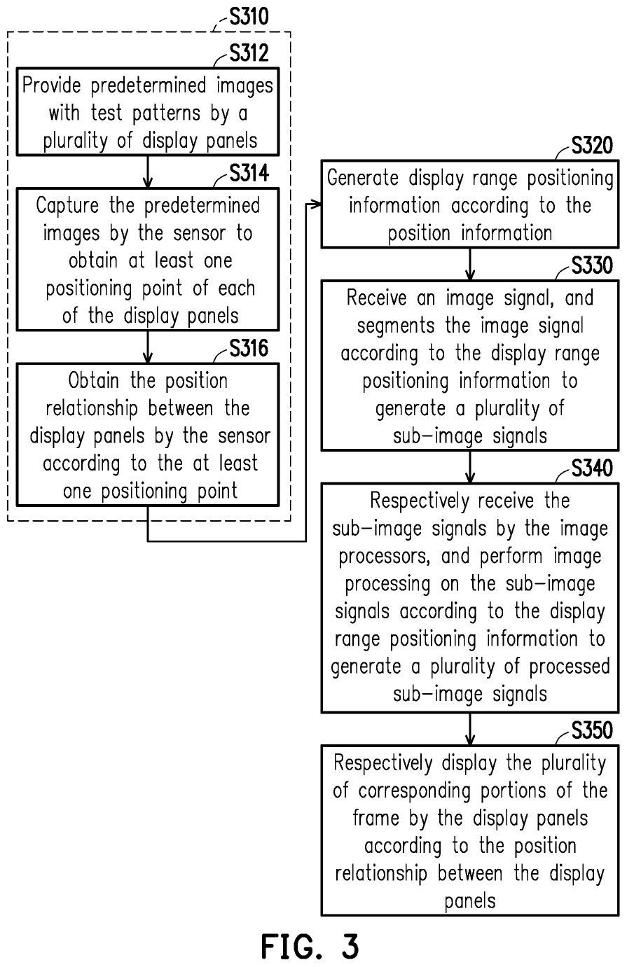

Further, an implementation detail of the step S210 may be different according to a type of the sensor 130. Referring to FIG. 1 and FIG. 3, FIG. 3 is a flowchart illustrating a display method according to another embodiment of the invention. In the embodiment, the sensor 130 is, for example, an image sensor configured to capture images of the display device 120. The sensor 130 may be disposed at external of the display device 120. In the embodiment, the sensor 130 may capture images of the display panels 124_1-124_4 to obtain the position relationship between the display panels. In detail, in the display method of the embodiment, a step S310 may be compared with the step S210 of FIG. 2. The step S310 further includes steps S312, S314 and S316. First, in the step S312, the display panels 124_1-124_4 provide predetermined images with test patterns. The predetermined images may be regarded as test templates at the beginning of the display method of the embodiment. The predetermined images may be, for example, at least one color image different from a background color, or the predetermined image may be, for example, images of different colors presented by each of the display panels. In the step S314, the sensor 130 captures the predetermined images displayed by the display panels 124_1-124_4 to obtain at least one positioning point of the display panel 124_1, at least one positioning point of the display panel 124_2, at least one positioning point of the display panel 124_3, and at least one positioning point of the display panel 124_4. The positioning points may be position coordinates of edges or corners of the predetermined images captured by the sensor 130. In the step S316, the sensor 130 may obtain the position relationship of the display panels 124_1-124_4 according to the positioning points, so as to generate the position information PI of the display panels 124_1-124_4.

In the embodiment, the steps S320-S350 may be compared with the steps S220-S250 of FIG. 2. Enough instructions for implementation details of the steps S320-S350 may be learned from the embodiments of FIG. 1 and FIG. 2, which are not repeated.

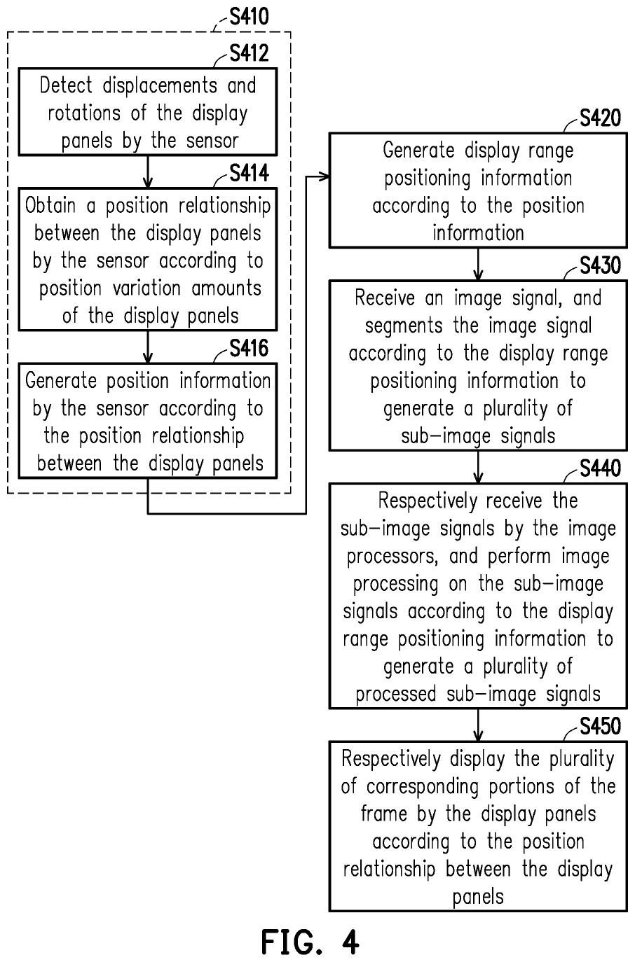

Referring to FIG. 1 and FIG. 4, FIG. 4 is a flowchart illustrating a display method according to still another embodiment of the invention. In the embodiment, the sensor 130 may include a plurality of Inertial Measurement Units (IMU). In the embodiment, the IMUs are respectively disposed on the display panels 124_1-124_4. In detail, in the display method of the embodiment, a step S410 may be compared with the step S210 of FIG. 2. The step S410 may further include steps S412, S414 and S416. First, in the step S412, the plurality of IMUs may detect displacements and rotations of the corresponding display panels 124_1-124_4 at any time. The IMU includes a gyroscope and an accelerometer. In the embodiment, the gyroscopes are configured to detect rotations of the corresponding display panels 124_1-124_4. The accelerometers are configured to detect displacements of the corresponding display panels 124_1-124_4. In some embodiments, in the step S412, the display panels 124_1-124_4 respectively return to predetermined positions (for example, referential origins or mechanical origins) and respectively restore rotation angles to predetermined angles (for example, 0°) to implement initialization. Once the initialization is completed, the IMUs start to detect displacements and rotations of the corresponding display panels 124_1-124_4 during the assembling of the display panels 124_1-124_4. In the step S414, the IMUs respectively obtain the position relationship between the display panels 124_1-124_4 according to position variation amounts in displacements and rotations of the display panels 124_1-124_4. The position variation amounts include displacement distances and directions of the display panels 124_1-124_4 and rotation angels of the display panels 124_1-124_4. Then, in the step S416, the processor 130 generates the position information PI of the display panels 124_1-124_4 according to the position relationship between the display panels 124_1-124_4. In the embodiment, the steps S420-S450 may be compared with the steps S220-S250 of FIG. 2. Enough instructions for implementation details of the steps S420-S450 may be learned from the embodiments of FIG. 1 and FIG. 2 or the embodiments of FIG. 1 and FIG. 3, which are not repeated.

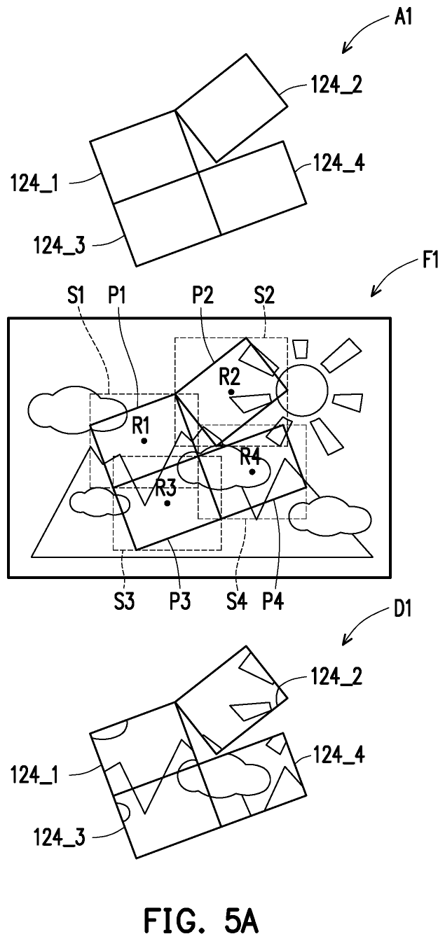

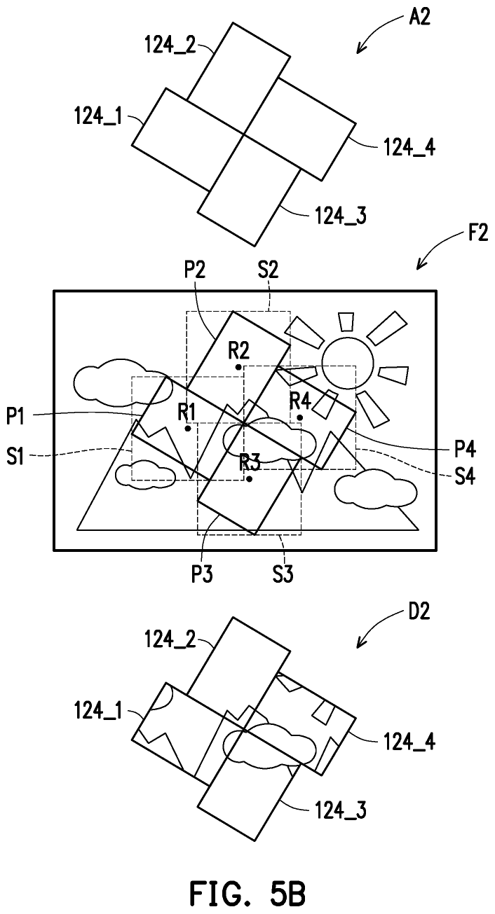

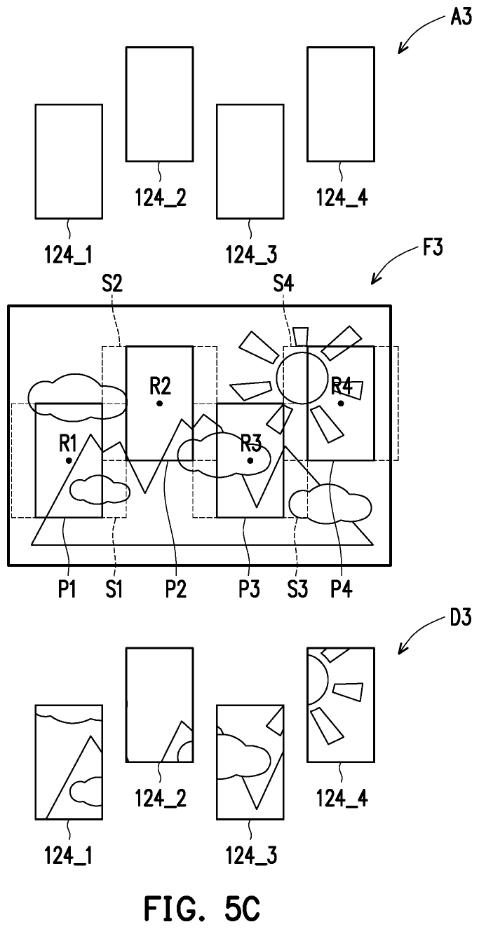

Multiple usage situations of the display system are described below. Referring to FIG. 1 and FIG. 5A, FIG. 5A is a schematic diagram of a usage situation according to an embodiment of the invention. In the embodiment, the display panels 124_1, 124_3 and 124_4 have a same first rotation angle, and the display panel 124_2 has a second rotation angle different to the first rotation angle of the display panels 124_1, 124_3 and 124_4 (shown as an assembly A1), where the rotation angle is, for example, an included angle of each of the display panels 124_1, 124_2, 124_3 and 124_4 relative to a gravity direction, but the invention is not limited thereto. The sensor 130 is configured to provide the position information PI generated according to the position relationship between the display panels 124_1-124_4. The host 140 generates the display range positioning information DRPI according to the positioning information PI, where the display range positioning information DRPI includes display ranges of each of the display panels 124_1-124_4 corresponding to the frame F and reference center points R1-R4 of each of the display panels 124_1-124_4 in the corresponding display ranges. The image receiving distributor 110 segments the received image signal IMGS according to the display range positioning information DRPI, so as to generate the sub-image signals IMGS_1-IMGS_4. The sub-image signals IMGS_1-IMGS_4 respectively correspond to the blocks S1-S4 of the image (shown as a frame F1).

Then, the image processors 122_1, 122_3 and 122_4 respectively perform image processing on the sub-image signals IMGS_1, IMGS_3 and IMGS_4 (for example, a rotation processing opposite to the first rotation angle, i.e. to perform the rotation processing and geometric processing of the display range on the blocks S1, S3 and S4 of the frame F1) to generate the processed sub-image signals IMGS_1 ‘, IMGS_3’ and IMGS_4′. The image processors 122_2 performs image processing on the sub-image signal IMGS_2 (for example, a rotation processing opposite to the second rotation angle, i.e. to perform the rotation processing and geometric processing of the display range on the block S2 of the frame F1) to generate the processed sub-image signal IMGS 2′. In this way, the display panels 124_1-124_4 may respectively display the corresponding portions P1-P4 of the frame F1 according to the processed sub-image signals IMGS_1 ‘-IMGS_4’, so as to achieve an image-splicing display effect (shown as a display effect DD.

Referring to FIG. 1 and FIG. 5B, FIG. 5B is a schematic diagram of a usage situation according to another embodiment of the invention. Different to the FIG. 5A, the display panels 124_1-124_4 of the embodiment are assembled in a fan-blade mode (shown as an assembly A2). Similar to the FIG. 5A, the image receiving distributor 110 segments the received image signal IMGS according to the display range positioning information DRPI to generate the sub-image signals IMGS_1-IMGS_4. The sub-image signals IMGS_1-IMGS_4 respectively correspond to the blocks S1-S4 of the image (shown as a frame F2). Similar to the FIG. 5A, the image processors 122_1-122_4 respectively perform image processing on the sub-image signals IMGS_1-IMGS_4 to generate the processed sub-image signals IMGS_1 ‘-IMGS_4’. In this way, the display panels 124_1-124_4 may respectively display the corresponding portions P1-P4 of the frame F2 according to the processed sub-image signals IMGS_1 ‘-IMGS_4’, so as to achieve an image-splicing display effect (shown as a display effect D2).

Referring to FIG. 1 and FIG. 5C, FIG. 5C is a schematic diagram of a usage situation according to still another embodiment of the invention. In the embodiment, the display panels 124_1-124_4 are rotated by 90° and are not adjacent to each other (shown as an assembly A3). The sensor 130 provides the position information PI generated according to the position relationship between the display panels 124_1-124_4. After the host 140 generates the display range positioning information DRPI, the image receiving distributor 110 segments the received image signal IMGS according to the display range positioning information DRPI, so as to generate the sub-image signals IMGS_1-IMGS_4. The portions P1-P4 of the frame F3 corresponding to the sub-image signals IMGS_1-IMGS_4 are also not adjacent to each other. The sub-image signals IMGS_1-IMGS_4 respectively correspond to the blocks S1-S4 of the image (shown as a frame F3). Then, the image processors 122_1-122_4 respectively perform image processing (for example, rotation processing of 90° and geometric processing of the display range) on the sub-image signals IMGS_1-IMGS_4 to generate the processed sub-image signals IMGS_1′-IMGS_4′. In this way, the display panels 124_1-124_4 may respectively display the corresponding portions P1-P4 of the frame F3 according to the processed sub-image signals IMGS_1 ‘-IMGS_4’, and the portions P1-P4 corresponding to the processed sub-image signals IMGS_1′-IMGS_4′ are also not adjacent to each other, so as to achieve the image-splicing display effect (shown as a display effect D3).

In summary, the display system of the invention generates the display range positioning information according to the position information between the display panels. The image receiving distributor segments the image signal according to the received display range positioning information. Each of the image processors performs the image processing on the corresponding sub-image signals according to the display range positioning information to generate a plurality of processed sub-image signals. The display panels respectively receive the processed sub-image signals, and display the plurality of corresponding portions of the frame according to the position relationship between the display panels. In this way, the display system may achieve the image-splicing display effect in response to arbitrary assembling mode of the plurality of display panels.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A display system, comprising:
an image receiving distributer, configured to receive an image signal, and segment the image signal to generate a plurality of sub-image signals;
a display device, coupled to the image receiving distributor, and comprising a plurality of image processors and a plurality of image processors, wherein:
the image processors are configured to respectively receive the sub-image signals, and each of the image processors performs image processing on the corresponding sub-image signals to generate a plurality of processed sub-image signals; and
the display panels are respectively coupled to the image processors, wherein the image signal corresponds to an frame, the sub-image signals correspond to a plurality of different blocks of the frame, the blocks corresponding to the sub-image signals respectively form a plurality of different portions corresponding to the processed sub-image signals after the image processing, the display panels respectively receive the processed sub-image signals, and respectively display the corresponding portions of the frame according to a position relationship between the display panels;
a sensor, configured to provide position information generated according to the position relationship between the display panels;
a host, coupled to the sensor and the image receiving distributor, configured to receive the position information outputted from the sensor, and generate display range positioning information according to the position information, wherein the image receiving distributor segments the image signal according to the received display range positioning information, and each of the image processors performs the image processing on the corresponding sub-image signals according to the display range positioning information.

2. The display system as claimed in claim 1, wherein a first image processor in the image processors is coupled to a first display panel in the display panels, and is configured to receive a first sub-image signal in the sub-image signals, and perform the image processing on the first sub-image signal according to the display range positioning information to generate a processed first sub-image signal.

3. The display system as claimed in claim 2, wherein
the first display panel is configured to receive the processed first sub-image signal, and display the processed first sub-image signal according to a position of the first display panel,
the portion of the frame corresponding to the processed first sub-image signal corresponds to the position of the first display panel on the display device.

4. The display system as claimed in claim 1, wherein the image processing comprises at least one of displacement processing, rotation processing, geometric processing of a display range and warping processing.

5. The display system as claimed in claim 1, wherein:
the sensor is an image sensor,
the sensor is configured to capture images of the display panels to obtain the position relationship between the display panels.

6. The display system as claimed in claim 5, wherein the sensor is further configured to capture predetermined images displayed by the display panels to obtain at least one positioning point of each of the display panels, and obtain the position relationship between the display panels according to the at least one positioning point.

7. The display system as claimed in claim 1, wherein
the sensor comprises a plurality of inertial measurement units,
the inertial measurement units are respectively disposed on the display panels, and configured to obtain the position relationship between the display panels according to position variation amounts of the display panels.

8. The display system as claimed in claim 1, wherein the host calculates a display range of the display panels and generate the display range positioning information, and the display range positioning information comprises shapes of the display panels and distances and angles between the display panels.

9. The display system as claimed in claim 1, wherein the display panels and the image processors are detachably assembled into the display device.

10. A display method of a display system, wherein the display system comprises a display device, the display device comprises a plurality of display panels and a plurality of image processors, and the display panels are respectively coupled to the image processors, the display method comprising:
providing position information generated according to a position relationship between the display panels;
generating display range positioning information according to the position information;
receiving an image signal, and segmenting the image signal according to the display range positioning information to generate a plurality of sub-image signals, wherein the image signal corresponds to a frame, and the sub-image signals correspond to a plurality of different blocks of the frame;
respectively receiving the sub-image signals by the image processors, and performing image processing on the sub-image signals according to the display range positioning information to generate a plurality of processed sub-image signals, wherein the blocks corresponding to the sub-image signals respectively form a plurality of different portions corresponding to the processed sub-image signals after the image processing; and
respectively receiving the processed sub-image signals by the display panels, and respectively displaying the plurality of corresponding portions of the frame according to the position relationship between the display panels.

11. The display method of the display system as claimed in claim 10, wherein the image processing comprises at least one of displacement processing, rotation processing, geometric processing of a display range and warping processing.

12. The display method of the display system as claimed in claim 10, wherein the step of providing the position information generated according to the position relationship between the display panels comprises:
capturing images of the display panels by an image sensor to obtain the position relationship between the display panels.

13. The display method of the display system as claimed in claim 12, wherein the step of providing the position information generated according to the position relationship between the display panels comprises:
displaying predetermined images by the display panels;
capturing the predetermined images by the image sensor to obtain at least one positioning point of each of the display panels; and
obtaining the position relationship between the display panels according to the at least one positioning point.

14. The display method of the display system as claimed in claim 10, wherein the step of providing the position information generated according to the position relationship between the display panels comprises:
providing position variation amounts of the display panels by a plurality of inertial measurement units; and
obtaining the position relationship between the display panels according to the position variation amounts of the display panels.

15. The display method of the display system as claimed in claim 10, wherein the step of generating the display range positioning information according to the position information comprises:
calculating a display range of the display panels and generating the display range positioning information, wherein the display range positioning information comprises shapes of the display panels and distances and angles between the display panels.

16. The display method of the display system as claimed in claim 10, wherein the step of segmenting the image signal according to the display range positioning information to generate the sub-image signals comprises:
segmenting the image signal by an image receiving distributor according to the display range positioning information.

17. A display device, adapted to a display system, comprising:
a plurality of image processors, configured to receive a plurality of sub-image signals generated by segmenting an image signal, and perform image processing on the sub-image signals to generate a plurality of processed sub-image signals; and
a plurality of display panels, respectively coupled to the image processors, wherein the image signal corresponds to a frame, the sub-image signals correspond to a plurality of different blocks of the frame, wherein the plurality of blocks corresponding to the sub-image signals respectively form a plurality of different portions corresponding to the processed sub-image signals after the image processing, the display panels are respectively configured to receive the processed sub-image signals, and respectively display the plurality of corresponding portions of the frame according to a position relationship between the display panels,
wherein the display system provides position information generated according to the position relationship between the display panels, and generates display range positioning information according to the position information, and each of the image processors performs the image processing on the corresponding sub-image signal according to the display range positioning information.

18. The display device as claimed in claim 17, wherein a first image processor in the image processors is coupled to a first display panel in the display panels, and is configured to receive a first sub-image signal in the sub-image signals, and perform the image processing on the first sub-image signal according to the display range positioning information to generate a processed first sub-image signal in the processed sub-image signals.

19. The display device as claimed in claim 18, wherein
the first display panel is configured to receive the processed first sub-image signal, and display the processed first sub-image signal according to a position of the first display panel,
the portion of the frame corresponding to the processed first sub-image signal corresponds to the position of the first display panel on the display device.

20. The display device as claimed in claim 17, wherein the image processing comprises at least one of displacement processing, rotation processing, geometric processing of a display range and warping processing.

21. The display device as claimed in claim 17, wherein the display system captures images of the display panels to obtain the position relationship between the display panels.

22. The display device as claimed in claim 21, wherein
the display panels are configured to provide predetermined images,
the display system captures the predetermined images to the obtain at least one positioning point of each of the display panels, and obtain the position relationship between the display panels according to the at least one positioning point.

23. The display device as claimed in claim 17, further comprising:
a plurality of inertial measurement units, respectively disposed on the display panels, and configured to obtain the position relationship between the display panels according to position variation amounts of the display panels.
